(19) United States
(12) Patent Application Publication
(10) Pub. No.: US 2022/0382649 A1
(43) Pub. Date: Dec. 1, 2022

(54) RESTORE ASSISTANT: USING AUGMENTED BACKUP METADATA FOR STEP-BY-STEP RESTORE GUIDE

(71) Applicant: EMC IP Holding Company LLC, Hopkinton, MA (US)

(72) Inventors: Jehuda Shemer, Kfar Saba (IL); Arieh Don, Newton, MA (US); Krishna Deepak Nuthakki, Bangalore (IN)

(21) Appl. No.: 17/380,926

(22) Filed: Jul. 20, 2021

(30) Foreign Application Priority Data
May 27, 2021 (IN) 202111023669

(51) Int. Cl. G06F 11/14

(52) U.S. Cl. CPC G06F 11/1464; G06F 11/1451; G06F 11/1461; G06F 11/1435

(57) ABSTRACT

One example method includes accessing augmented metadata that was stored in connection with a backup dataset, analyzing the augmented metadata, based on the analyzing, creating a guide that identifies processes which, when performed, cause the restoration of the backup dataset to an unsupported target array, and presenting the guide to a user by way of a user interface. The user may then perform the actions indicated in the guide to restore the backup dataset to the unsupported target array.

### FIELD OF THE INVENTION

Embodiments of the present invention generally relate to data backup and restore processes. More particularly, at least some embodiments of the invention relate to systems, hardware, software, computer-readable media, and methods for the use of augmented backup metadata to facilitate data restore processes.

### BACKGROUND

Conventional backup software for block storage volumes typically stores some metadata along with the backup copy. Usually this metadata is very basic, such as volume identity, size and block size, and backup time and backup method, related information. This basic metadata is sufficient to enable most backup and data restore operations. To illustrate DellEMC products such as PPDM, Avamar and NetWorker, store only this basic metadata. However, problems arise when attempts are made to restore relatively old backups.

Particularly, backups may be stored for several years. When a restore operation of an old backup is attempted, it is up to the storage admin or backup admin to determine what is needed in order to successfully restore the volume. To illustrate, when a 7 year old backup is restored, the storage system from which that backup was taken likely does not exist anymore. Moreover, the current storage admin may not even be familiar with the older storage system from which the backup was taken. A simple volume may be relatively easy to restore using only basic metadata. However, if there is a need to restore not just the volume data, but also information and data such as the operational state of the volume, the SLO (Service Level Objective) for space management for the volume, and who should have access to the restored volume, basic metadata will not be adequate to enable such a restore process.

While a complete automation of the logistics needed for a restore may be preferred, that is not always possible or practical. For example, such an approach would require backup of significantly more metadata than is employed typically. As well, the backup software would be required to support a wide range of storage systems, and also be compatible with the older storage system. Such compatibility would be difficult, if not impossible, to implement.

As a final example, some data storage services store customer data that is relatively old and may be stored on legacy media such as tape for example. In order to be able to recover and restore this data from the legacy media, the data storage service must employ legacy equipment such as tape drives, and old mainframe computers. This equipment is costly to maintain since parts are difficult to obtain, and it may be difficult to locate personnel with the skills needed to operate and maintain such equipment.

To briefly summarize then, block volume backups typically do not have or use detailed metadata for backups. Instead, only basic identification and information is typically kept. Another problem not addressed by conventional backup and restore systems and operations is that some backups may be stored for years before being restored. In such circumstances, it is common that the storage system form which the data was taken is no longer in service and/or the current admin may not be familiar with the configuration and operation of that system. Finally, some volumes that have been stored for a long time before being targeted for restoration may be part of and SG (Storage Group), or other structures. If a volume is part of an SG, other elements of the SG, which have not been backed up with the volume, may nonetheless be important to the performance of some restore operations.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example process for determining when a restore assistant will be run.

FIG. 2 discloses aspects of example operations of a restore assistant.

FIG. 3 discloses aspects of an example computing entity operable to perform any of the disclosed methods, processes, and operations.

### DETAILED DESCRIPTION OF SOME EXAMPLE EMBODIMENTS

Embodiments of the present invention generally relate to data backup and restore processes. More particularly, at least some embodiments of the invention relate to systems, hardware, software, computer-readable media, and methods for the use of augmented backup metadata to facilitate data restore processes.

In general, example embodiments of the invention may store all storage related metadata. As well, example embodiments may create and use a “restore assistant” which, among other things, may analyze the stored backup metadata and may create a step by step guide, which may be in a wizard form accessible by a user using a UI such as a GUI (Graphical User Interface) or CLI (Command Line Interface), that may enable a storage admin to restore the backup. If the restore target storage management system is fully integrated by the backup software, operations of the restore assistant may be run automatically. Otherwise, the restore assistant may create a text or interactive guide to the procedures that the admin must follow in order to successfully restore the backed up data. As such, embodiments of the invention may enable restoration, to a new system or old system, of even the most complex, and old, backup copies, notwithstanding that the storage system from which the backup copies were taken may no longer exist at the time of restoration.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that relatively old backups may be restored even if the systems and equipment used to make those backups do not exist, or are not in service, at the time of the restore. An embodiment may enable restoration of old backups even if the backup admin or other user is unfamiliar with the equipment and systems that were used to create and store the backup. As a final example, an embodiment may provide an interactive guide that may guide a user through a process to restore old backups, even if the user has little or no knowledge about the equipment and systems that were used to create and store the backup.

A. Aspects of Some Example Operating Environments

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, 10 replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

Finally, as used herein, the term ‘backup’ is intended to be broad in scope. As such, example backups in connection with which embodiments of the invention may be employed include, but are not limited to, full backups, partial backups, clones, snapshots, and incremental or differential backups.

B. Aspects of Some Example Embodiments

As noted earlier, embodiments of the invention may employ augmented metadata to enable restoration of old backups that may not otherwise be restorable due to a lack of available systems and processes, and/or a lack of knowledge concerning the operation of, systems and processes that were used to create the backup. In this regard, it is noted that an admin coming to restore a backup could come with little or no knowledge of the history of the backup or of the systems and processes that created and stored the backup. For example, the admin may be new to the job, the backup could be several years old, and/or, there could be hundreds of systems in the datacenter where the backup is to be restored from. As such, example embodiments may assume little or no knowledge on the part of the admin.

In at least some embodiments, all volume, array, and operational, metadata that is available at the time of backup, may be stored when the backup is stored. Any or all of this metadata may be stored with the backup, or separately from the backup.

B.1 Example Metadata Stored for Use in Data Restore Processes

Following are examples of information, such as metadata, that may be available on storage arrays, and which may be added to the backup information, in accordance with example embodiments. The following examples of augmented metadata may be employed together with basic metadata, examples of which are disclosed herein, to help enable restoration of backup data. Particularly, such information may include, but is not limited to the following.
1. Device identity including:
   a. IDs in multiple formats;
   b. Names, nice names, aliases;
   c. Federated IDs; and
   d. SCSI face or interface information—Vendor/Product (these may have been spoofed and may not be the default array values).
2. Access control information:
   a. Read only/write protect/read-write;
   b. User authorization; and
   c. ACL information.
3. Storage Group/Port group:
   a. SG identification the volume was part of;
   b. List of other volumes in that group; and
   c. Any other SG settings available on the array.
4. Masking into (# of ports and directors it was masked to)
5. SLO related information.
6. Policy information.
7. Storage pool and provisioning type info—for example, what backing storage was used for this volume (SATA/SSD/tier/caching)—this may overlap SLO and policy in some cases, but not always.
8. Application related information—if the device was marked to belong to an application by text or bit masks.
9. Encryption related information—if the encryption is storage array based or if there is metadata that states what encryption exists, include details about the key management server (KMS) and key hints.
10. Compression information.
11. Host related or multipathing information (such as from DellEMC PowerPath). This information may include Hostname, OS details (version, patch level), Power Path details (version, patch level), initiator wwn and other like VM, Cluster info. This information may not be stored on the storage array at volume level but may be derived by looking up path and initiator information.
12. Any other array or volume level information.

B.2 Use of Metadata For Data Restore Processes

Following are some examples where augmented metadata may be employed to assist in data restore processes, as well as some examples of particular metadata and how it may be used to effectuate a restore process.

1. Scenario 1: A volume where a backup is stored was originally part of an SG (Storage Group). In some cases at least, SGs tend to have correlation with application layout or volume cross consistency. If a volume that is to be restored was part of a SG, it may be the case that other volumes of the same SG need to be restored as well in order to get a fuller restore of an application. The SG designation and volume list may allow for easier tracing of this.

2. Scenario 2: The admin is requested to restore not only the data, but also restore a full running system. Restoring a running system may require operational information such as, but not limited to, access, user info and masking info for example. Also, some systems require a minimum storage performance to be able to run. Having the SLO, policy and provisioning information may allow proper provisioning of the restore volumes to meet these requirements. Volume masking may also be performance related as it affects the number of paths the volume can be accessed by.

3. Compression information may point to the nature of the data compressibility and select more efficient targets for restoration of the data.

4. Application information may provide insights regarding system level operations that are required in order to allow proper application operation. For example, if it is noted that the volume was an Exchange Server volume, the admin will need the Exchange application in order to be able to access the data properly, and to validate that the restore operation did indeed restore correctly.

5. Additional metadata allows for better search operations to find the correct backup copy to restore. That is, the more metadata that is stored in connection with the backup process, the more readily the backup copy may be located at restore time, since there is more information to search for.

B.3 Aspects of An Example Restore Assistant

Example embodiments may provide for the use of a restore assistant that may take the form of an interactive tool operable to guide a user through a restore process for a backup that may have been stored for a long time and/or that was created using systems and processes no longer in service, or unavailable for some reason. The restore assistant may also be useful in circumstances where the user must restore data but the user is unfamiliar with the systems and processes that were used to create and store the backup.

The restore assistant may be included as an element of a backup/restore server in some embodiments. In other embodiments, the restore assistant may operate as a separate stand-alone utility that is accessible by any entity/user that may be involved in a data restore process. In still other embodiments, the restore assistant may be hosted at the target array to which the data is to be restored. The scope of the invention is not limited to any particular implementation of a restore assistant.

With regard to the restore assistant, if the backup software should be fully integrated with the target storage array control path and management, the restore operation and some of the bureaucracies of the storage array may be already handled by the backup software. As described above however, more can be done once the full scope of metadata is available to the restore operation.

Consider, for example, a situation where a target array is not supported, that is, the backup was initially created and stored using processes and systems different from, and possibly incompatible/inconsistent with, those of the target array to which the data is to be restored such that without the use of augmented metadata and a restore assistant, as disclosed herein, the backup cannot be restored to the target array. Put another way, target array may be referred to as unsupported if it is unable to receive and/or restore a dataset without the use of augmented metadata and/or the use of a restore assistant.

In conventional approaches where the target array is not supported, a successful restore, if possible at all, may be completely dependent upon the knowledge and capabilities of the admin. Thus, example embodiments provide for a restore assistant that may create, in response to instantiation of a restore process and/or at other times, a human readable summary of the metadata information and the restore assistant may also highlight special operations or processes to be performed to implement a successful restore. In this regard, simply dumping out the metadata, or giving the admin access to the metadata, even if the metadata is augmented metadata, may not be sufficient to ensure a successful restore, since such a restore may require not only augmented metadata, but also knowledge of the original array configuration to understand.

In some embodiments, a restore assistant will access stored augmented metadata that is associated with a backup, and the restore assistant may call out, or otherwise present to a user, such as by way of a display or other user interface, the augmented metadata regarding the volume to be restored. The augmented metadata may be in a form that is readable, and/or otherwise perceptible, by a human. Such augmented metadata may include, for example:
1. Volume identification;
2. Volume size;
3. Provisioning type or hints;
4. SLO and performance related tips—high IOPs, high throughput, for example;
5. Access control and wiring—combining access and masking info;
6. Application related info—from an application associated with the data to be restored, or SG, that is information about a SG of which the volume to be restored was part;
7. Other volumes that may be related to the backup copy to be restored; and
8. Any other special considerations that the admin should be aware of.

After the restore assistant has provided augmented metadata to the user, the restore assistant may then provide, again by way of a UI, detailed operation steps which, when performed by, or at the direction of, the user, may cause restoration of the volume to the target array. Some examples of such detailed operations steps are set forth below.

One example of detailed operation guidance provided by a restore assistant to a user, such as by way of a UI, may be as follows:
1. Provision a 100 GB high-IOPs SSD volume and name it “main_exchange_43_11_restored”;
2. The volume is part of a 3 volume SG—make sure you restore volumes “main_exchange_43_12” and “main_exchange_43_26” as well;
3. Restore the data from the backup copy to the volume, and note that this volume is part of a group—restore all group volumes from the same point in time;
4. Set all restored volumes access to “write protected”;
5. Add all the restored volumes to a group and provided them with the same port access parameters—note that this is a high IOPs access volume and therefore should be exposed to multiple ports/paths to enable proper performance; and
6. The volume was marked as encrypted with storage side AES encryption—the key hint was “1981-Sam-the-Great.”
   Guided by the restore assistant, these actions may be performed by a user, such as an admin for example, to successfully restore a backup dataset, or volume, to a target array. This restoration may be performed using augmented metadata, and may be successfully performed even if: (i) the admin is unfamiliar with the systems and processes that were used to create and store the backup; and/or (ii) the systems and processes used to create the backup are no longer in service, or are unavailable for some reason, at the time of the restore.

C. Example Methods

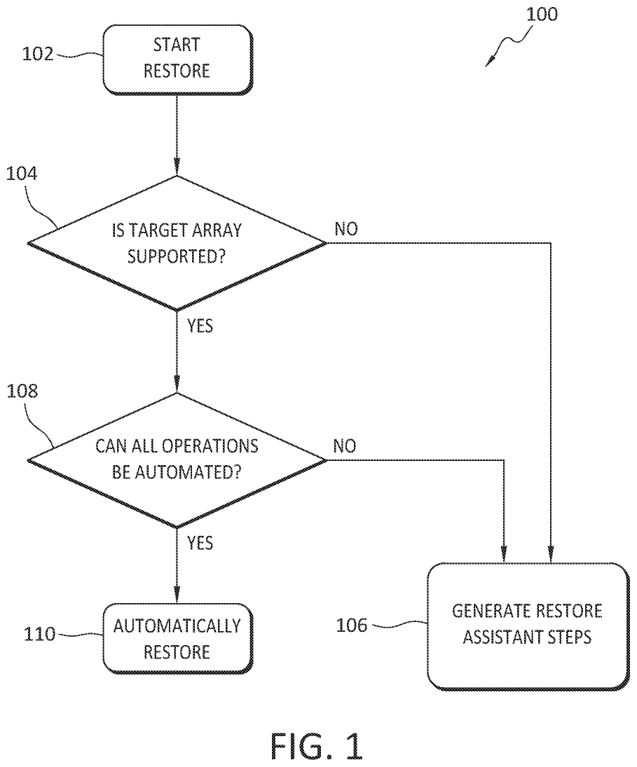

It is noted with respect to the example method of FIG. 1 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Directing attention now to FIG. 1, details are provided concerning an example process 100 for determining when a restore assistant should be used to guide a user through a restore operation for a volume or other data. The method 100 may begin when a restore operation is initiated 102. The restore operation may be initiated 102 automatically, or at the initiative of a human. As part of the initiation 102 of the restore operation, or before/after initiation, a determination 104 may be made as to whether or not the target array to which the data will be restored is supported. That is, whether or not the backup to be restored was initially created and stored using processes and systems different from, and possibly incompatible/inconsistent with, those processes and systems of the target array to which the data is to be restored such that without the use of augmented metadata and the restore assistant, the backup cannot be restored to the target array.

If the target array is determined 104 not to be supported, the restore assistant may be automatically invoked, and may generate 106 a list of processes to be performed to restore the dataset. The processes may be presented to a user in a user-perceptible form so that the user can take the necessary action to perform, or cause the performance of, the processes identified by the restore assistant.

If it is determined at 104 that the target array is supported, that is, the target array is compatible with, or is the same as, the processes and systems that were used to create the backup, the method 100 may advance to 108 where a determination is made as to whether or not all of the operations needed to restore the data can be performed automatically, that is, performed by the restore system without human participation in the restore process. If automatic performance is determined 108 not to be possible, the method 100 may advance to 106 where the restore assistant generates a list of the processes needed for restoration, and the restore assistant then guides a human user through performance of part or all of the restore process.

On the other hand, if it is determined at 108 that all of the restore operations can be performed automatically, the method 100 may advance to 110. At 110, the restore operations may be automatically performed, and may not require the involvement of a human user, or the involvement of the restore assistant.

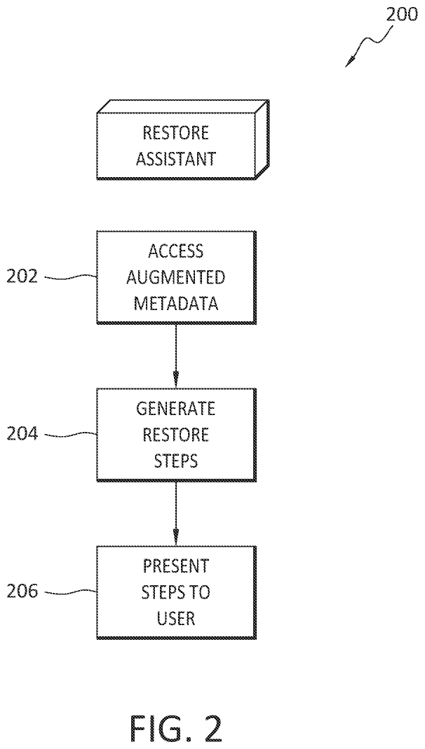

With reference next to FIG. 2, an example method 200 is disclosed concerning the operation of an example restore assistant. The method 200 may be instantiated automatically, or on the initiative of a human user. In either case, when it is determined that the restore assistant will be involved in a restore process, the restore assistant may access 202 augmented metadata related to the data that is to be restored. The augmented metadata may or may not be stored in the same location as the data to be restored.

Based on examination of the augmented metadata by the restore assistant, the restore assistant may then generate 204 a workflow or restore steps. The restore steps, when performed by a human and/or a computing entity, may result in successful restoration of a dataset to a target array.

After the restore steps have been generated 204 by the restore assistant, the restore assistant may present those steps 206 to a user for action. When the processes presented 206 to the user are performed by the user, and/or at the direction of the user, the dataset may be restored to, and accessible at, a target array.

D. Further Example Embodiments

Following are some further example embodiments of the invention. These are presented only by way of example and are not intended to limit the scope of the invention in any way.

Embodiment 1. A method, comprising: accessing augmented metadata that was stored in connection with a backup dataset; analyzing the augmented metadata; based on the analyzing, creating a guide that identifies processes which, when performed, cause the restoration of the backup dataset to an unsupported target array; and presenting the guide to a user by way of a user interface.

Embodiment 2. The method as recited in embodiment 1, wherein the augmented metadata comprises metadata other than basic metadata, wherein the basic metadata is adequate to enable restoration of the backup dataset to a supported target array.

Embodiment 3. The method as recited in any of embodiments 1-2, wherein performance of the method is triggered by instantiation of a restore process.

Embodiment 4. The method as recited in any of embodiments 1-3, wherein the guide is a step-by-step set of instructions for restoring the backup dataset.

Embodiment 5. The method as recited in any of embodiments 1-4, wherein the method is performed after a determination has been made that the target array is unsupported and/or after a determination is made that all restore operations needed to restore the backup dataset cannot be performed automatically.

Embodiment 6. The method as recited in any of embodiments 1-5, wherein the backup dataset cannot be restored to the target array without the use of augmented metadata and/or without the use of the restore assistant.

Embodiment 7. The method as recited in any of embodiments 1-6, wherein the restore assistant is implemented as a utility that is accessible by a backup and restore server.

Embodiment 8. The method as recited in any of embodiments 1-7, wherein the backup dataset is restorable without the use of legacy systems or legacy software.

Embodiment 9. The method as recited in any of embodiments 1-8, wherein the target array is relatively newer than the backup dataset and newer than systems and software that generated the backup dataset.

Embodiment 10. The method as recited in any of embodiments 1-9, wherein the processes, when performed, also cause restoration of an operational state of the backup dataset to the unsupported target array.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

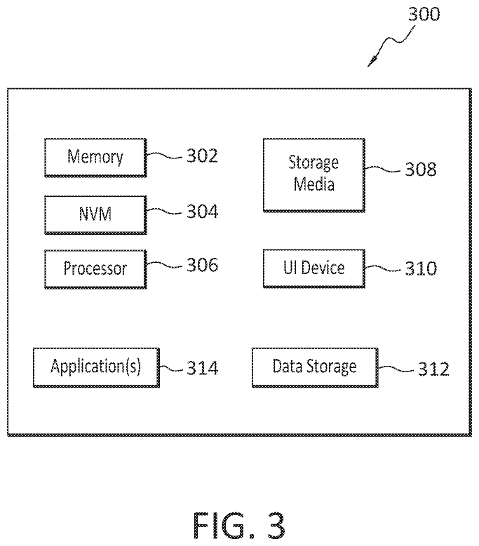

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
accessing augmented metadata that was stored in connection with a backup dataset;
analyzing the augmented metadata;
based on the analyzing, creating a guide that identifies processes which, when performed, cause the restoration of the backup dataset to an unsupported target array; and
presenting the guide to a user by way of a user interface.

2. The method as recited in claim 1, wherein the augmented metadata comprises metadata other than basic metadata, wherein the basic metadata is adequate to enable restoration of the backup dataset to a supported target array.

3. The method as recited in claim 1, wherein performance of the method is triggered by instantiation of a restore process.

4. The method as recited in claim 1, wherein the guide is a step-by-step set of instructions for restoring the backup dataset.

5. The method as recited in claim 1, wherein the method is performed after a determination has been made that the target array is unsupported and/or after a determination is made that all restore operations needed to restore the backup dataset cannot be performed automatically.

6. The method as recited in claim 1, wherein the backup dataset cannot be restored to the target array without the use of augmented metadata and/or without the use of the restore assistant.

7. The method as recited in claim 1, wherein the restore assistant is implemented as a utility that is accessible by a backup and restore server.

8. The method as recited in claim 1, wherein the backup dataset is restorable without the use of legacy systems or legacy software.

9. The method as recited in claim 1, wherein the target array is relatively newer than the backup dataset and newer than systems and software that generated the backup dataset.

10. The method as recited in claim 1, wherein the processes, when performed, also cause restoration of an operational state of the backup dataset to the unsupported target array.

11. A computer readable storage medium having stored therein instructions that are executable by one or more hardware processors to perform operations comprising:
accessing augmented metadata that was stored in connection with a backup dataset;
analyzing the augmented metadata;
based on the analyzing, creating a guide that identifies processes which, when performed, cause the restoration of the backup dataset to an unsupported target array; and
presenting the guide to a user by way of a user interface.

12. The computer readable storage medium as recited in claim 11, wherein the augmented metadata comprises metadata other than basic metadata, wherein the basic metadata is adequate to enable restoration of the backup dataset to a supported target array.

13. The computer readable storage medium as recited in claim 11, wherein performance of the computer readable storage medium is triggered by instantiation of a restore process.

14. The computer readable storage medium as recited in claim 11, wherein the guide is a step-by-step set of instructions for restoring the backup dataset.

15. The computer readable storage medium as recited in claim 11, wherein the computer readable storage medium is performed after a determination has been made that the target array is unsupported and/or after a determination is made that all restore operations needed to restore the backup dataset cannot be performed automatically.

16. The computer readable storage medium as recited in claim 11, wherein the backup dataset cannot be restored to the target array without the use of augmented metadata and/or without the use of the restore assistant.

17. The computer readable storage medium as recited in claim 11, wherein the restore assistant is implemented as a utility that is accessible by a backup and restore server.

18. The computer readable storage medium as recited in claim 11, wherein the backup dataset is restorable without the use of legacy systems or legacy software.

19. The computer readable storage medium as recited in claim 11, wherein the target array is relatively newer than the backup dataset and newer than systems and software that generated the backup dataset.

20. The computer readable storage medium as recited in claim 11, wherein the processes, when performed, also cause restoration of an operational state of the backup dataset to the unsupported target array.
